(19) United States
(12) Patent Application Publication
(10) Pub. No.: US 2025/0156418 A1
(43) Pub. Date: May 15, 2025

(54) TECHNIQUES TO IMPROVE QUERY PERFORMANCE USING DYNAMIC FILTERING BASED ON LEFT-JOIN AGGREGATION PATTERN

(71) Applicant: WORKDAY, INC., Pleasanton, CA (US)

(72) Inventors: Hanumath Rao MADURI, Fremont, CA (US); Karthik RAJAGOPAL, San Carlos, CA (US); Gary HECK, Pleasanton, CA (US)

(21) Appl. No.: 18/508,460

(22) Filed: Nov. 14, 2023

(51) Int. Cl. G06F 16/2453

(52) U.S. Cl. CPC G06F 16/24544; G06F 16/24537

(57) ABSTRACT

In some implementations, the techniques described herein relate to a method including: receiving, by a query engine, a database query, the database query including an inner query having inner query conditions and an outer query having outer query conditions; determining, by the query engine, that a number of rows responsive to the outer query exceeds a threshold; determining, by the query engine, that the inner query conditions and the outer query conditions are correlated; rewriting, by the query engine, the inner query conditions to include at least one of the outer query conditions to generate an optimized query; and executing, by the query engine, the optimized query on a database.

### BACKGROUND

In modern database systems, query performance is critical for ensuring timely retrieval and manipulation of data. Users often run complex queries that involve joining large tables and performing aggregation operations. While various query optimizers exist to improve the efficiency of these queries, the existing solutions often require substantial manual effort to implement or rely on statistical characteristics that may not be current, resulting in suboptimal performance.

### BRIEF DESCRIPTION OF THE FIGURES

FIG. 1 is a block diagram illustrating a database system according to some of the disclosed embodiments.

FIG. 2 is a block diagram illustrating a query engine according to some of the disclosed embodiments.

FIG. 3 is a flow diagram illustrating a method for optimizing a query using dynamic filtering according to some of the disclosed embodiments.

FIG. 4 is a block diagram of a computing device according to some embodiments of the disclosure.

### DETAILED DESCRIPTION

The disclosed embodiments present a novel approach to database query optimization focusing on left-join aggregation patterns. Specifically, it introduces a dynamic filter that identifies certain patterns in user queries, particularly those involving a large outer table and a join operation with an inner table. The query engine automatically rewrites the query to filter rows at an earlier stage during the join operation, thereby dramatically improving the efficiency of aggregation operations such as a sum operation etc. This transformation results in a performance improvement in the systems that run the herein disclosed operations that is proportionate to the number of rows being processed from the outer table.

The disclosed embodiments solve the inefficiency of query performance involving left-join aggregation patterns. Traditional optimization techniques, like cost-based optimizations, are often ineffective for this specific issue, as they rely on statistical data that may not always be up to date. By contrast, the disclosed embodiments implement a dynamic filter that adjusts the query tree and automatically applies filtering logic to the inner query based on the output of rows from the outer table. The described solution thus addresses the technical limitations of existing database query optimizers, delivering a significant improvement in efficiency for specific types of queries.

In some implementations, the techniques described herein relate to a method including: receiving, by a query engine, a database query, the database query including an inner query having inner query conditions and an outer query having outer query conditions; determining, by the query engine, that a number of rows responsive to the outer query exceeds a threshold; determining, by the query engine, that the inner query conditions and the outer query conditions are correlated; rewriting, by the query engine, the inner query conditions to include at least one of the outer query conditions to generate an optimized query; and executing, by the query engine, the optimized query on a database.

In some implementations, the techniques described herein relate to a method, wherein receiving a database query includes receiving a structured query language (SQL) statement.

In some implementations, the techniques described herein relate to a method, wherein determining that the number of rows responsive to the outer query exceeds a threshold includes replacing a select list of the outer query to generate a second query and executing the second query on a database.

In some implementations, the techniques described herein relate to a method, wherein replacing the select list includes replacing the inner query of the database query with a COUNT operation.

In some implementations, the techniques described herein relate to a method, wherein determining that the number of rows responsive to the outer query exceeds a threshold includes computing a ratio of the number of rows responsive to the outer query to a total size of an outer table queried by the outer query.

In some implementations, the techniques described herein relate to a method, wherein determining that the inner query conditions and the outer query conditions are correlated includes identifying a joining condition in the inner query.

In some implementations, the techniques described herein relate to a method, wherein rewriting the inner query conditions to include at least one of the outer query conditions to generate an optimized query includes executing the outer query, modifying the inner query conditions to generate a new inner query, executing the new inner query, and joining results of the new inner query with results of the outer query.

In some implementations, the techniques described herein relate to a non-transitory computer-readable storage medium for tangibly storing computer program instructions capable of being executed by a computer processor, the computer program instructions defining steps of: receiving, by a query engine, a database query, the database query including an inner query having inner query conditions and an outer query having outer query conditions; determining, by the query engine, that a number of rows responsive to the outer query exceeds a threshold; determining, by the query engine, that the inner query conditions and the outer query conditions are correlated; rewriting, by the query engine, the inner query conditions to include at least one of the outer query conditions to generate an optimized query; and executing, by the query engine, the optimized query on a database.

In some implementations, the techniques described herein relate to a non-transitory computer-readable storage medium, wherein receiving a database query includes receiving a structured query language (SQL) statement.

In some implementations, the techniques described herein relate to a non-transitory computer-readable storage medium, wherein determining that the number of rows responsive to the outer query exceeds a threshold includes replacing a select list of the outer query to generate a second query and executing the second query on a database.

In some implementations, the techniques described herein relate to a non-transitory computer-readable storage medium, wherein replacing the select list includes replacing the inner query of the database query with a COUNT operation.

In some implementations, the techniques described herein relate to a non-transitory computer-readable storage medium, wherein determining that the number of rows responsive to the outer query exceeds a threshold includes computing a ratio of the number of rows responsive to the outer query to a total size of an outer table queried by the outer query.

In some implementations, the techniques described herein relate to a non-transitory computer-readable storage medium, wherein determining that the inner query conditions and the outer query conditions are correlated includes identifying a joining condition in the inner query.

In some implementations, the techniques described herein relate to a non-transitory computer-readable storage medium, wherein rewriting the inner query conditions to include at least one of the outer query conditions to generate an optimized query includes executing the outer query, modifying the inner query conditions to generate a new inner query, executing the new inner query, and joining results of the new inner query with results of the outer query.

In some implementations, the techniques described herein relate to a device including: a processor; and a storage medium for tangibly storing their own program logic for execution by the processor, the program logic including: logic, executed by the processor, for receiving a database query, the database query including an inner query having inner query conditions and an outer query having outer query conditions; logic, executed by the processor, for determining that a number of rows responsive to the outer query exceeds a threshold; logic, executed by the processor, for determining that the inner query conditions and the outer query conditions are correlated; logic, executed by the processor, for rewriting the inner query conditions to include at least one of the outer query conditions to generate an optimized query; and logic, executed by the processor, for executing the optimized query on a database.

In some implementations, the techniques described herein relate to a device, wherein receiving a database query includes receiving a structured query language (SQL) statement.

In some implementations, the techniques described herein relate to a device, wherein determining that the number of rows responsive to the outer query exceeds a threshold includes replacing a select list of the outer query to generate a second query and executing the second query on a database.

In some implementations, the techniques described herein relate to a device, wherein replacing the select list includes replacing the inner query of the database query with a COUNT operation.

In some implementations, the techniques described herein relate to a device, wherein determining that the number of rows responsive to the outer query exceeds a threshold includes computing a ratio of the number of rows responsive to the outer query to a total size of an outer table queried by the outer query.

In some implementations, the techniques described herein relate to a device, wherein determining that the inner query conditions and the outer query conditions are correlated includes identifying a joining condition in the inner query.

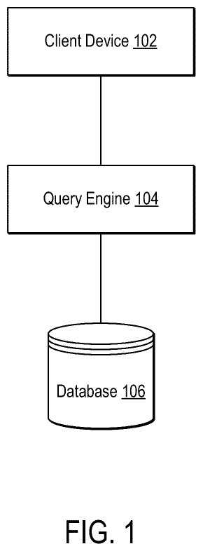

FIG. 1 is a block diagram illustrating a database system according to some of the disclosed embodiments.

The illustrated database system includes a client device 102, a query engine 104, and a database 106. Client device 102 issues queries, such as structured query language (SQL) queries, to query engine 104. Query engine 104 processes the queries, including performing the optimizations described herein, and issues optimized queries to database 106. Database 106 executes the optimized queries, generating a result, and returns the result to query engine 104. Query engine 104 then returns then returns the responsive results to client device 102, with or without further post-processing (e.g., paging, streaming, etc.).

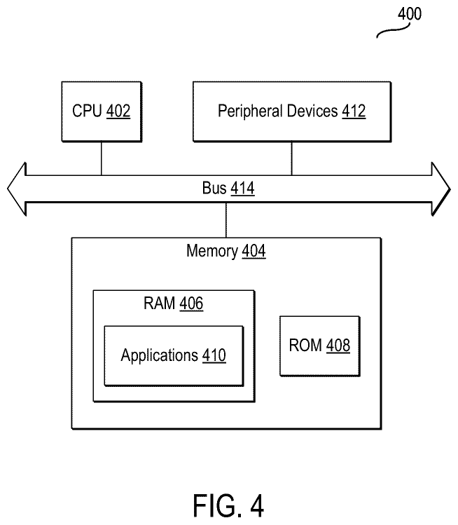

In some implementations, client device 102 can comprise a computing device capable of generating and transmitting queries to query engine 104. In some implementations, the queries can comprise SQL queries, although the specific language is not necessarily limiting. In some implementations, the client device 102 can comprise a general purpose computing device such as that depicted in FIG. 4. In some implementations, the client device 102 can issue queries over a network interface to query engine 104. As one example, client device 102 may comprise a web application that issues queries to query engine 104 to aid in generating web pages or web applications for transmission to end users. As another example, client device 102 can comprise a desktop application running on a single computing device that operates both query engine 104 and database 106. As such, query engine 104 and database 106 may or may not be installed on client device 102. Further details of the components of client device 102 are described in FIG. 4.

Query engine 104 may likewise comprise a computing device that can receive queries from external devices such as client device 102. Alternatively, or in conjunction with the foregoing, query engine 104 can comprise a software application that receives SQL queries via an application programming interface (API) accessible by the client device 102. For example, query engine 104 may comprise a compiled library that may be included in application code running on client device 102. Conversely, query engine 104 may comprise a network device exposing its own network endpoint for receiving queries from client device 102.

Query engine 104 may perform a variety of functions. In general, the query engine 104 is responsible for executing queries such as SQL queries and performing other data retrieval operations. In some implementations, the query engine 104 can transform queries into a series of low level instructions and execute these to produce the desired output. In some implementations, the query engine 104 can perform various optimization techniques to enhance performance such as parsing the query into a query tree and transforming it based on rules or statistical data to minimize computational cost. In some implementations, the query engine 104 can include components for indexing to speed up data retrieval, caching to store frequently accessed data, and concurrency control to manage multiple simultaneous queries. The query engine 104 can also perform error handling and transaction management to ensure the integrity and reliability of the database 106.

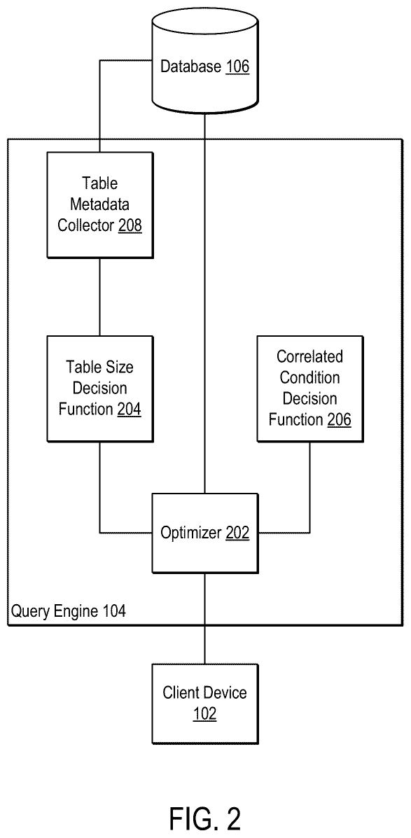

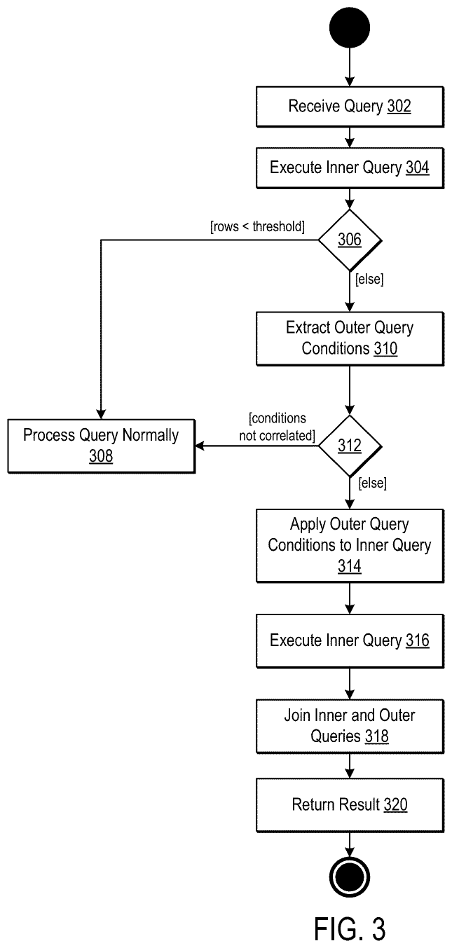

Query engine 104 can also perform specific optimizations based on the format of the SQL queries it receives and statistics about the tables that those SQL queries access. Specifically, in some implementations, query engine 104 can parse an incoming SQL query to determine if the tables the query accesses meet specified criteria for optimization. Further, the query engine 104 can analyze conditions of the SQL query to determine if there are correlated, or overlapping, conditions affecting multiple tables within a given query. In some implementations, when query engine 104 determines that both of these criteria are met it can perform a dynamic filtering optimization on the query. Specific details of this dynamic filtering optimization process are described more fully in FIGS. 2 and 3, the disclosure of which is not repeated herein.

In the illustrated embodiment, database 106 may comprise a data storage device. In some implementations, this data storage device may comprise a relational database. For example, database 106 may comprise a MySQL database, an Oracle database, a PostgreSQL database, or other similar types of databases. The specific vendor of database is not limiting. In general, any database that supports SQL queries may be utilized. Further, any database that supports query languages sharing the same characteristics with SQL described herein may also be used. The specific details on the operation and storage of database 106 are not described in detail here for the sake of clarity. Generally, database 106 will receive queries, execute those queries, and return a result set of responsive rows to the query engine 104.

In response to a result set returned from the database 106, the query engine 104 may perform post-processing on the results prior to returning a result to the client device 102. For example, the query engine 104 may sort results return from the database 106 based on conditions in the query. As another example, the query engine 104 may defer some filters or transformations to be applied after the database 106 returns its results. As another example the query engine 104 may perform pagination, aggregation, and formatting of results into a suitable format for the client device 102 (e.g., formatting into a DataFrame or Java Script Object Notation format). As another example, the query engine 104 may perform error handling and issue flagging for any issues raised by the database 106. Certainly, in some implementations, the database 106 may perform some or all of these functions and the query engine 104 may not be required to perform these functions.

FIG. 2 is a block diagram illustrating a query engine according to some of the disclosed embodiments.

As illustrated, a query engine 104 receives queries from a client device 102. As discussed in the description of FIG. 1, the query engine 104 will optimize the queries and issue them to the database 106. The query engine 104 can receive the results from the database 106 and return the results to the client device 102. FIG. 2 illustrates the subcomponents of the query engine 104.

As illustrated, the query engine 104 includes an optimizer 202. The optimizer 202 communicates with a table size decision function 204 to first determine if the size of the table included in the query meets a predefined constraint. In some implementations, the table size decision function 204 receives database table statistics from a table metadata collector 208. In some implementations, the table metadata collector 208 can periodically receive table statistics from the database 106. As one example, the table metadata collector 208 can receive the sizes of database tables from database 106. In some implementations, a size can be represented as a total number of rows in a table. The table size decision function 204 will return a value to the optimizer 202 to indicate whether optimization is possible based on the table sizes and/or row sizes of an outer query. The optimizer 202 can also communicate with a correlated condition decision function 206 which will analyze the conditions of a query to determine if the conditions on an outer table are correlated with the conditions on an inner table within the query. If table size decision function 204 and correlated condition decision function 206 return positive results, the optimizer 202 will perform an optimization on the query to generate the optimized query. The optimizer 202 will then issue the query to the database 106 and receive and return the results to the client device 102.

In the illustrated embodiment, the optimizer 202 may comprise a software component configured to receive the original query from client device 102. As discussed, the query may comprise an SQL query received in plain text or other suitable format for parsing. In some implementations, the optimizer 202 may perform various optimizations to the original query as discussed above. The optimizer 202 may also perform a dynamic filtering optimization using the table size decision function 204 and the correlated condition decision function 206. In this respect the optimizer 202 may forward the received SQL query to both decision functions and receive an indication of whether a given SQL query can be optimized using the dynamic filtering optimization described herein.

In some implementations, the table size decision function 204 determines whether a dynamic filtering optimization is possible based on the size of the underlying tables. In some implementations, the table size decision function 204 may utilize a tunable threshold that specifies a minimum size of an outer query table queried in an SQL query. In some implementations, the table size decision function 204 may make this determination based on the total size of the outer query table in an SQL query. In some implementations, the table size decision function 204 may retrieve table statistics from table metadata collector 208. In some implementations, the table metadata collector 208 will periodically update the sizes of tables stored in database 106. In these implementations, the table size decision function 204 may estimate the size of the result set resulting from the outer query and its conditions. Such an implementation may provide a close estimate of the size of the resulting outer table. However, the estimate may or may not be close enough to the actual result size. Thus, while this approach minimizes database access and is quicker, the disclosed embodiments describe a second approach for determining if the size of an outer table is suitable for dynamic filtering optimization.

In these other implementations, the table size decision function 204 may issue a query to the database 106 using the outer query and any conditions to return a result set. The table size decision function 204 may then analyze the returned result size (i.e., the number of rows) and determine if this result size is above the tunable threshold. Consider, for example, the following SQL query:

```
  SELECT
  (SELECT SUM(COL_B_1) AS P0 FROM tableB AS B1
    WHERE (COL_B_2 = A0.ID)
AND (COL_B_3 = 12345)) AS P0,
  ID AS P4
  FROM tableA AS A0
  WHERE (COL_A_1 = 4321)
  AND ((COL_A_2 >= 1210)
  AND (COL_A_2 <= 1310))
```

Here, the outer table query can be expressed as:

```
SELECT * FROM tableA AS A0
  WHERE (COL_A_1 = 4321)
    AND ((COL_A_2 >= 1210)
    AND (COL_A_2 <= 1310))
```

As illustrated, the inner query is removed so as to return all columns from tableA that meet the outer query conditions. In some implementations, a COUNT function can be used to return only the number of rows and not the actual data:

```
SELECT COUNT(*) FROM tableA AS A0
  WHERE (COL_A_1 = 4321)
    AND ((COL_A_2 >= 1210)
  AND (COL_A_2 <= 1310))
```

In this implementation, the table size decision function 204 can return the exact size of the outer table used in the query. In some implementations, the cost of performing this separate query is minimal and thus feasible. In some implementations, the table size decision function 204 will return a binary result to the optimizer 202. For example, the table size decision function 204 will return true if the size of the outer query table exceeds the tunable threshold or false if the size of the outer query table is equal to or less than the tunable threshold. In this manner, table size decision function 204 acts as a check to prevent dynamic filtering optimization on queries where the benefit will be minimal.

In general, the dynamic filtering optimization provides significant benefits when the outer query table is a large table but only a few rows are emitted due to the outer query conditions. Thus, in another implementation both of the above approaches may be utilized. Specifically, the table metadata collector 208 can be queried to find the total size of the outer query table. Next, the outer query can be executed as provided above to obtain the actual number of rows used from that table. When these methods are combined, the ratio between the two values can be compared to us a ratio of threshold to determine whether only a small percentage of rows from a large table are returned from the outer query. Certainly, in this example and in the first implementation, the table metadata collector 208 can be implemented as a generalized query to select a row count from the outer table, such as: SELECT COUNT(*) FROM tableA.

As illustrated, the query engine 104 additionally includes a correlated condition decision function 206. This decision function acts as an independent and second check on the received SQL query to determine if dynamic filtering optimization is appropriate. Specifically, the correlated condition decision function 206 will analyze the conditions of the outer query and the inner query to determine if there is an overlap between the two sets of conditions. As used herein, conditions refer to the SQL query conditions modifying the result set returned. For example, the SQL WHERE statement can be used to define conditions and can include multiple logical groupings of conditions. Using the above query as an example the conditions of the outer query are:

```
(COL_A_1 = 4321)
  AND ((COL_A_2 >= 1210)
    AND (COL_A_2 <= 1310))
```

Similarly, the conditions of the inner query are:

(COL_B_2 = A0.ID)
AND (COL_B_3 = 12345))

In this example, the sets of conditions are correlated via the first condition of the inner query which ties the results of that query to the ID column of the outer query table (A0.ID). Thus, in some implementations the correlated condition decision function 206 can detect this relationship between the outer conditions and the inner conditions and return a Boolean value indicating whether or not the conditions are correlated and thus suitable for dynamic filtering optimization.

Returning to optimizer 202, the optimizer 202 will receive the Boolean results from both decision functions and determine whether or not to optimize the SQL query based on the results. Specifically, optimizer 202 will only optimize the original query using dynamic filtering optimization if both results are true or positive. Thus, optimizer 202 will only perform the dynamic filtering optimization if the properties of the outer table and the correlation of the conditions are aligned.

If optimizer 202 determines to perform the dynamic filtering optimization on the original SQL query, optimizer 202 will rewrite the query according to the dynamic filter. Further details of this rewriting are provided in the description of FIG. 3 and are not repeated herein. In general, optimizer 202 will rewrite the SQL query to include some or all of the outer conditions into the inner query. For example, optimizer 202 may rewrite the previous SQL query as follows:

```
SELECT
  (SELECT SUM(COL_B_1) AS P0
    FROM tableB AS B1, tableA as A2
    WHERE (COL_B_2 = A0.ID)
      AND (COL_B_3 = 12345)
      AND B0.C5633_486=A2.ID
      AND (COL_A_1 = 4321)
      AND (COL_A_2 >= 1210)
      AND (COL_A_2 <= 1310)) AS P0,
  ID AS P4
FROM tableA AS A0
WHERE (COL_A_1 = 4321)
  AND ((COL_A_2 >= 1210)
    AND (COL_A_2 <= 1310))
```

As can be seen, the inner query retains it's original conditions (COL_B_2=A0.ID and COL_B_3=12345). Next, the inner query is joined with the outer query table (FROM tableB AS B1, tableA as A2 and the condition B0.C5633_486=A2.ID). Finally, the outer query conditions are added to the WHERE clause of the inner query (COL_A_1=4321, COL_A_2>=1210, COL_A_2<=1310). The resulting query performs significantly faster than the original query because the join between tableB and tableA filters out most of the rows and the aggregation operation, for example SUM, executes quickly. By contrast, the original query performs a join on a larger table (the entire tableA) which results in a slower execution time. Furthermore, the dynamic filtering optimization proportionately improves the performance as the size of the outer table increases. Further, since the size of the outer table and the correlation of conditions can be performed programmatically, the dynamic filtering optimization can be deployed automatically and at scale and does not require human intervention to be performed. Thus, the dynamic filtering optimization can be implemented in an existing query engine and thus transparent to the client device 102. Further functional aspects of query engine 104 are described more fully in the following FIG. 3.

FIG. 3 is a flow diagram illustrating a method for optimizing a query using dynamic filtering according to some of the disclosed embodiments.

In step 302, the method can include receiving a query.

In some implementations, the query comprises an SQL query. In other implementations the query can comprise any other type of query language that has a similar or the same properties as the SQL features described above. In some implementations, the query can comprise a text query. However, in other implementations no limit is placed on the specific format of the query. For example, the SQL query can be serialized or otherwise converted into a transport format and then deserialized or otherwise converted to a suitable format add a query engine.

In some implementations, the query will include at least one outer query and at least one inner query. Specific details of inner and outer queries have been discussed with examples in the preceding description and are not repeated herein for the sake of clarity. In some implementations, the SQL query can include multiple outer and/or multiple inner queries. In such implementations, the method may be performed on all outer and inner queries as necessary.

In some implementations, the method may receive the query over a network. In such an implementation, the method may be implemented on a network computing device such as a database server. In other implementations, the query may be received via an application call, for example, via a library installed on a device. For example application code running on a device may access a linked library, shared object, or similar type of application programming interface to transmit a query to the method.

In some implementations, step 302 can also include converting a textual representation of the query into a tree based format of the query. For example, step 302 may include generating a query tree of the query suitable for later parsing. The specific details of parsing a text query into a query tree are not described herein for the sake of clarity and any known or to be known technique may be used.

In step 304, the method can include executing an outer query.

In some implementations, an outer query comprises a SELECT statement using outer table identifier and a set of outer query conditions which place the limit on the rows returned from the outer table. In some implementations, the method analyzes the received query to identify this outer table. In some implementations, a query tree representation can be used to quickly identify this outer table query based on the structure of the tree.

In some implementations, the method can extract this outer query and issue a call to the database to count the number of rows responsive to the outer query. As discussed above, this can include executing the query and returning a full set of results and then counting the results. In other implementations, the method can generate a new query based on the outer query that only returns a count of the responsive results. Specifically, as discussed above the method can extract the outer query and replace the select list with an operation such as COUNT(*) to count the number of rows in the outer query.

In some implementations, step 304 can further include determining a total size of the outer table utilized by the outer query. In one embodiment, this can include accessing a database of metadata describing the size of the tables including the outer table. In another embodiment, this can include issuing a second query without any conditions to the same outer table. As in the previous example, this may include using a COUNT operation to count the total number of rows in the table.

In step 306, the method can include determining if the number of rows responsive to the outer query is above or below a threshold.

In the first implementation, the method in step 306 can determine if the number of results responsive to the outer query is above or below a tunable threshold. In some implementations, the tunable threshold can be defined in advance before the method executes and may be set according to the operator's needs. In other implementations, the tunable threshold can be changed dynamically based on observing how long queries are taking. For example, the method may monitor the execution time for all queries and modify the threshold if queries that are not optimized using dynamic filters are still executing slowly. In some implementations, this can include decreasing the threshold value which would increase the number of queries subjected to dynamic filtering optimization.

In a second implementation, the method may compute a ratio between the number of rows returned from the outer query and the total size of the outer table. This ratio thus represents the amount of data returned from the query as a percentage of the total table size. In some implementations, this ratio can be indicative of how much of the table the outer query is using. As discussed above, outer queries that are not using a significant portion of the table are prime candidates for optimization.

In step 308, the method can process the received query normally if the number of rows in the outer query is below a threshold number of rows.

In some scenarios, a given query may not be suitable for optimization using dynamic filtering. As a simplistic example, an outer query that places no conditions on the return data will return all of the data in the outer table and thus the optimization may not be useful in that scenario. Certainly, other sets of conditions may also return a large amount of data and thus render the query sub-optimal for optimization. In this scenario the check in step 306 will fail and the method will proceed to step 308 where it will process the query normally without dynamic filtering optimizations. The specific means of executing a query normally are not limiting or described in detail herein and may be performed by the database management system. By contrast, when the outer table is large, and the number of affected rows is small, the method proceeds to step 310.

In step 310, if the method determines that the number of rows from the outer query are above or equal to a threshold the method can then extract the outer query conditions from the query.

In this step, the method first extracts the conditions of the outer query. In some implementations, the method can utilize the abstracts and text tree of the query and identify conditions or filters that are present in the query itself. Generally, these query conditions will take the form of a Boolean expression in a WHERE clause of the outer query. No limit is placed on the number of query conditions that can be extracted and indeed any number of query conditions can be extracted.

In step 312, the method can include determining if the outer query conditions are correlated to inner query conditions.

In some implementations, the method can then analyze the query conditions of the inner query. Similar to the outer query conditions, the inner query conditions can take the form of a Boolean expression in a WHERE clause of the inner query. In some implementations, the method can parse the inner query conditions to determine if there is a joining condition in the inner query conditions. In general, such a joining condition will require that one column value in the inner table is equal to another column value in the outer table, thus performing a join. If such a correlated condition exists, the method will proceed to step 314, described next.

If the outer query conditions are not correlated with the inner query conditions, the method proceeds to step 308 where it processes the query normally. Details of step 308 were provided previously and are not repeated herein.

In step 314, the method can include applying the outer query conditions to an inner query of the query received in step 302.

As discussed above, the inner query conditions and the outer query conditions may both be represented as Boolean expressions. As such, the method can apply the outer query conditions to the inner query by combining, as a Boolean expression, the outer query conditions and the inner query conditions. For example, the method can join the inner query conditions and the outer query conditions with an AND operator. In some implementations, the method can further comprise reducing or optimizing the Boolean expression using Boolean algebra to reduce the number of terms and thus conditions in the query conditions.

In step 316, the method can include executing the inner query.

In some implementations, this can include issuing the inner query including the combined query conditions to the database. Since the two queries have a correlated condition, the resulting inner query that includes the combined conditions will comprise a join between the inner table and the outer table. However, the outer conditions applied to the outer table will significantly reduce the number of rows from the larger outer table that are used in the join. As discussed above, since a decision was made to optimize only when the outer query condition significantly reduced the result set size, this improvement can be guaranteed. Furthermore, the performance improvement actually enhances as the size of the outer table increases.

In step 318, the method can include joining the inner and outer queries. After receiving the results of the inner query, the method may join that result set with the outer query result set. In some implementations, the results of the outer query may be cached as part of the decision-making functionality described above. Thus, the second join may be performed rapidly using the smaller result set from the inner query. The specific details of joining two queries is not described in detail herein and may be performed by the database management system.

In step 320, the method can include returning the results of the joined query to the client device. Finally, after computing the final result set, the method can return the result set to the client which issued the query in step 302. Details of returning results to a client device have been described previously and are not described herein.

FIG. 4 is a block diagram of a computing device according to some embodiments of the disclosure.

As illustrated, the device 400 includes a processor or central processing unit (CPU) such as CPU 402 in communication with a memory 404 via a bus 414. The device also includes one or more input/output (I/O) or peripheral devices 412. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 402 may comprise a general-purpose CPU. The CPU 402 may comprise a single-core or multiple-core CPU. The CPU 402 may comprise a system-on-a-chip (SoC) or a similar embedded system. In some embodiments, a graphics processing unit (GPU) may be used in place of, or in combination with, a CPU 402. Memory 404 may comprise a memory system including a dynamic random-access memory (DRAM), static random-access memory (SRAM), Flash (e.g., NAND Flash), or combinations thereof. In one embodiment, the bus 414 may comprise a Peripheral Component Interconnect Express (PCIe) bus. In some embodiments, the bus 414 may comprise multiple busses instead of a single bus.

Memory 404 illustrates an example of a non-transitory computer storage media for the storage of information such as computer-readable instructions, data structures, program modules, or other data. Memory 404 can store a basic input/output system (BIOS) in read-only memory (ROM), such as ROM 408 for controlling the low-level operation of the device. The memory can also store an operating system in random-access memory (RAM) for controlling the operation of the device.

Applications 410 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 406 by CPU 402. CPU 402 may then read the software or data from RAM 406, process them, and store them in RAM 406 again.

The device may optionally communicate with a base station (not shown) or directly with another computing device. One or more network interfaces in peripheral devices 412 are sometimes referred to as a transceiver, transceiving device, or network interface card (NIC).

An audio interface in peripheral devices 412 produces and receives audio signals such as the sound of a human voice. For example, an audio interface may be coupled to a speaker and microphone (not shown) to enable telecommunication with others or generate an audio acknowledgment for some action. Displays in peripheral devices 412 may comprise liquid crystal display (LCD), gas plasma, light-emitting diode (LED), or any other type of display device used with a computing device. a display may also include a touch-sensitive screen arranged to receive input from an object such as a stylus or a digit from a human hand.

A keypad in peripheral devices 412 may comprise any input device arranged to receive input from a user. An illuminator in peripheral devices 412 may provide a status indication or provide light. The device can also comprise an input/output interface in peripheral devices 412 for communication with external devices, using communication technologies, such as USB, infrared, Bluetooth®, or the like. a haptic interface in peripheral devices 412 provides tactile feedback to a user of the client device.

A GPS receiver in peripheral devices 412 can determine the physical coordinates of the device on the surface of the Earth, which typically outputs a location as latitude and longitude values. a GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

1. A method comprising:
receiving, by a query engine, a database query, the database query including an inner query having inner query conditions and an outer query having outer query conditions;
determining, by the query engine, that a number of rows responsive to the outer query exceeds a threshold;
determining, by the query engine, that the inner query conditions and the outer query conditions are correlated;
rewriting, by the query engine, the inner query conditions to include at least one of the outer query conditions to generate an optimized query; and
executing, by the query engine, the optimized query on a database.

2. The method of claim 1, wherein receiving a database query comprises receiving a structured query language (SQL) statement.

3. The method of claim 1, wherein determining that the number of rows responsive to the outer query exceeds a threshold comprises replacing a select list of the outer query to generate a second query and executing the second query on a database.

4. The method of claim 3, wherein replacing the select list comprises replacing the inner query of the database query with a COUNT operation.

5. The method of claim 1, wherein determining that the number of rows responsive to the outer query exceeds a threshold comprises computing a ratio of the number of rows responsive to the outer query to a total size of an outer table queried by the outer query.

6. The method of claim 1, wherein determining that the inner query conditions and the outer query conditions are correlated comprises identifying a joining condition in the inner query.

7. The method of claim 1, wherein rewriting the inner query conditions to include at least one of the outer query conditions to generate an optimized query comprises executing the outer query, modifying the inner query conditions to generate a new inner query, executing the new inner query, and joining results of the new inner query with results of the outer query.

8. A non-transitory computer-readable storage medium for tangibly storing computer program instructions capable of being executed by a computer processor, the computer program instructions defining steps of:
receiving, by a query engine, a database query, the database query including an inner query having inner query conditions and an outer query having outer query conditions;
determining, by the query engine, that a number of rows responsive to the outer query exceeds a threshold;
determining, by the query engine, that the inner query conditions and the outer query conditions are correlated;
rewriting, by the query engine, the inner query conditions to include at least one of the outer query conditions to generate an optimized query; and
executing, by the query engine, the optimized query on a database.

9. The non-transitory computer-readable storage medium of claim 8, wherein receiving a database query comprises receiving a structured query language (SQL) statement.

10. The non-transitory computer-readable storage medium of claim 8, wherein determining that the number of rows responsive to the outer query exceeds a threshold comprises replacing a select list of the outer query to generate a second query and executing the second query on a database.

11. The non-transitory computer-readable storage medium of claim 10, wherein replacing the select list comprises replacing the inner query of the database query with a COUNT operation.

12. The non-transitory computer-readable storage medium of claim 8, wherein determining that the number of rows responsive to the outer query exceeds a threshold comprises computing a ratio of the number of rows responsive to the outer query to a total size of an outer table queried by the outer query.

13. The non-transitory computer-readable storage medium of claim 8, wherein determining that the inner query conditions and the outer query conditions are correlated comprises identifying a joining condition in the inner query.

14. The non-transitory computer-readable storage medium of claim 8, wherein rewriting the inner query conditions to include at least one of the outer query conditions to generate an optimized query comprises executing the outer query, modifying the inner query conditions to generate a new inner query, executing the new inner query, and joining results of the new inner query with results of the outer query.

15. A device comprising:
a processor; and
a storage medium for tangibly storing program logic for execution by the processor, the program logic comprising:
logic, executed by the processor, for receiving a database query, the database query including an inner query having inner query conditions and an outer query having outer query conditions,
logic, executed by the processor, for determining that a number of rows responsive to the outer query exceeds a threshold,
logic, executed by the processor, for determining that the inner query conditions and the outer query conditions are correlated,
logic, executed by the processor, for rewriting the inner query conditions to include at least one of the outer query conditions to generate an optimized query, and
logic, executed by the processor, for executing the optimized query on a database.

16. The device of claim 15, wherein receiving a database query comprises receiving a structured query language (SQL) statement.

17. The device of claim 15, wherein determining that the number of rows responsive to the outer query exceeds a threshold comprises replacing a select list of the outer query to generate a second query and executing the second query on a database.

18. The device of claim 17, wherein replacing the select list comprises replacing the inner query of the database query with a COUNT operation.

19. The device of claim 15, wherein determining that the number of rows responsive to the outer query exceeds a threshold comprises computing a ratio of the number of rows responsive to the outer query to a total size of an outer table queried by the outer query.

20. The device of claim 15, wherein determining that the inner query conditions and the outer query conditions are correlated comprises identifying a joining condition in the inner query.
